(19) United States
(12) Patent Application Publication
(10) Pub. No.: US 2002/0141730 A1
(43) Pub. Date: Oct. 3, 2002

(54) TV recorder with inoperative settop box functions

(75) Inventor: Jack E. Haken, Danbury, CT (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/817,978

(22) Filed: Mar. 27, 2001

(51) Int. Cl. H04N 5/76

(52) U.S. Cl. 386/46; 386/83

(57) ABSTRACT

A programmable recorder that records video signals provided by a settop box includes monitoring circuitry which monitors a signal indicative of the operational state of the settop box and generates a state signal, logic circuitry which determines whether the settop box is operational based on the state signal and generates a determination signal, and control circuitry which effects a programmed response in response to the determination signal. If desired, the programmed response is cancellation of a schedule recording event. In an exemplary case, the programmable recorder includes an alarm circuit; thus, the programmed response is providing an alarm indicating that the settop box is not operational. In another exemplary case, the programmable recorder includes a communications circuit permitting communication between the programmable recorder and a settop box control facility, and the programmed response consists of transmitting an electronic message to settop box control facility indicating that the settop box is not operational. A memory storing computer readable instructions for permitting the programmable recorded to effect the monitoring and programmed responses and a corresponding signal are also described.

### BACKGROUND OF THE INVENTION

1. Field of the Invention

The present invention relates generally to a personal TV receiver (PTR). More specifically, the present invention relates to an improved PTR having the capability of recognizing that an upstream settop box is inoperative. Corresponding methods for operating the PTR so as to recognize an inoperable settop box are also disclosed.

2. Background of the Invention

A new type of consumer electronics product known by several names including a Personal Television Receiver (PTR), digital video recorder (DVR) or, simply, a disk buffered television (DBT), has recently been introduced into the home entertainment products market. A PTR is designed to replace or augment the family's conventional VCR by recording television to an internal hard drive instead of onto a tape. A typical PTR 100 includes a tuner 110, a MPEG-2 Encoder 120, a write random access memory (RAM) buffer 130, a disk drive 140, a read RAM buffer 150 and a MPEG-2 decoder 160 arranged in the order illustrated in FIG. 1. Each of these components is controlled by a CPU 300. Although identified as a MPEG-2 device, it should be noted that the video signal can be compressed using any intraframe or intraframe and interframe compression technique; thus, the video signal can be stored in any known video data format, including but not limited to, MPEG, MJPEG, AVI, DVI/RTV, Indeo Video, and the like. It will also be noted that disk drive 140 is preferably a high capacity hard disk drive, preferably having a capacity of tens of gigabytes. CPU 300 can, for example, be used in a known fashion to program the tuner 110 to select and record programs from predetermined channels at predetermined times.

It will be appreciated that one major advantage of the PTR over the conventional VCR is that the PTR is capable of recording one program while playing another program. It will be noted that PTR 100 also includes analog-to-digital and digital-to-analog converters (ADCs and DACS) for converting between analog signals suitable for driving a television display and digital data suitable for storage on disk drive 140. These, and additional elements, will be discussed in greater detail below.

Consumers purchasing a PTR will often install the device between a conventional cable television settop box or satellite television receiver, hereinafter simply settop box, and a television set, as illustrated in FIG. 2. The settop box permits the consumers to continue to receive premium channels and the like which cannot be accessed via the cable ready tuner 110 in the PTR 100. FIG. 2 illustrates one possible arrangement of an entertainment system 200 wherein the settop box 210 is connected to a television 220 via the PTR 100. It will be noted that the cables 230 and 240 [NOT SHOWN IN FIG. 2], which connect settop box 210 to PTR 100 and PTR 100 to television 220, respectively, can be one of coaxial cable, audio/video (A/V) cable, or S-video cable. An additional control channel 250/260 is provided between the settop box 210 and the PTR 100, as discussed in greater detail immediately below.

Current models of the PTR 100 control channel selection on settop box 210 via a one-way communications channel 250, which can include an infrared transmitter 252, which is placed opposite the remote control IR sensor 212 on the settop box 210, and a cable 254. It should be noted that the control channel 250 can be replaced by a serial cable 260 connecting corresponding serial ports (not shown) of the settop box 210 and the PTR 100. Both the control channel 250 and the serial cable 260 permit the PTR 100 to select the channel output by the settop box 210.

However, the PTR 100 does not make any effort to determine whether the settop box 210 is actually responding to its commands. Thus, when the settop box 210 is turned OFF (which can happen after a momentary power line dropout) or otherwise misses commands generated by the PTR 100, the PTR 100 will not record the desired program. Since many settop boxes include a toggle ON-OFF switch, sending a signal to toggle this switch will not alleviate the problem. In other words, simply sending an ON-OFF IR command as part of the switching sequence by which the PTR 100 is prepared for recording will produce indeterminate results, since the initial value of the toggle switch is itself indeterminate.

What is needed is an operating method and corresponding structure that will permit a PTR to determine whether or not a settop box is operating before commencing a scheduled recording event. What is also needed is a method and corresponding structure which permit will permit a PTR to attempt corrective action with respect to a non-operational settop box and to recognize whether the corrective action has been effective. What is also needed is a method and corresponding structure which permits the PTR to notify the user that the settop box is not operating and to suspend recording operations until the problem with the settop box has been rectified. Beneficially, the method permits the PTR to generate a series of control signals for application to the settop box that permits the PTR to characterize the operational state of the settop box.

### SUMMARY OF THE INVENTION

Based on the above and foregoing, it can be appreciated that there presently exists a need in the art for a personal television receiver (PTR) which overcomes the above-described deficiencies

In one aspect, the preferred embodiments according to the present invention provides an improved Personal Television Receiver (PTR) including components and associated logic which enable the PTR to determine whether the settop box is turned ON and/or is responding to the commands generated by the PTR before a program recording is initiated. When the PTR determines that the settop box is not responding properly, the PTR according to the present invention advantageously can attempt to restore the settop box to a responsive state by generating and applying a series of commands. Preferably, when it becomes apparent that the settop box cannot be returned to its normal operational state, the PTR suspends recording. In addition, the PTR can generate an alarm to alert the user to fact that the settop box requires servicing.

According to one aspect, the present invention provides a memory associated with a programmable TV recorder storing computer readable instructions for programming a processor to monitor an input port capable of receiving a video signal from a video signal source, to determine whether the video signal is recordable, and to generate an output when the processor determines that the video signal is not recordable. Stated another way, the present invention provides a memory associated with a programmable recorder storing computer readable instructions permitting a processor disposed within the programmable recorder to monitor an input port capable of receiving a video signal from a video signal source, to determine whether the video signal is recordable, and to generate an output when the programmable recorder determines that the video signal is not recordable. In an exemplary case, the video signal source is a settop box, the programmable recorder includes a modem permitting the programmable recorder to communicate with a settop box provider, and the output is an e-mail message to the settop box provider indicating that the settop box is not operational. In another exemplary case, the video source is an antenna, and the output is an alarm signal indicating that the programmable recorder is not receiving the video signal at the input port. If desired, the output can be employed to cancel a scheduled recording event.

According to another aspect, the present invention provides a memory associated with a programmable TV recorder storing computer readable instructions for programming a processor to monitor a video signal from a video signal source for changes, to determine, based on said changes, whether the video signal is recordable and to generate an output signal when the processor determines that the video signal is not recordable. In other words, the present invention provides a memory associated with a programmable recorder storing computer readable instructions permitting a processor disposed within the programmable recorder to monitor a video signal from a video signal source for changes, to determine whether the video signal is recordable based on the changes, and to generate an output when the programmable recorder determines that the video signal is not recordable. In an exemplary case, the programmable recorder monitors the video signal by analyzing the video signal, and determines that the video signal is recordable when the video signal analyzed by the programmable recorder is changing from line to line within a frame of the video signal. In an alternative exemplary case, the programmable recorder monitors the video signal by analyzing the video signal, and determines that the video signal is recordable when a number of lines of the video signal analyzed by the programmable recorder change from one frame to another frame. Moreover, the programmable recorder can monitor the video signal by analyzing the video signal, and determine that the video signal is recordable when the video signal analyzed by the programmable recorder varies dynamically in response to a variation in the video signal provided by the video signal source. In other words, the programmable recorder monitors the video signal and determines that the video signal is recordable when the video signal received by the programmable recorder is changing consistent with expected changes in a television program video signal. Alternatively, the programmable recorder can monitor the video signal by analyzing an audio signal associated with the video signal, and thereby determines that the video signal is recordable when the audio signal analyzed by the programmable recorder is not white noise.

According to yet another aspect, the present invention provides a programmable recorder for recording video signals provided by a settop box, including monitoring circuitry which monitors a signal indicative of the operational state of the settop box and generates a state signal, logic circuitry which determines whether the settop box is operational based on the state signal and generates a determination signal, and control circuitry which effects a programmed response in response to the determination signal. If desired, the programmed response is cancellation of a schedule recording event. In an exemplary case, the programmable recorder includes an alarm circuit; thus, programmed response is providing an alarm indicating that the settop box is not operational. In another exemplary case, the programmable recorder includes a communications circuit permitting communication between the programmable recorder and a settop box control facility, and the programmed response consists of transmitting an electronic message to settop box control facility indicating that the settop box is not operational. In one instance, the programmable recorder advantageously includes a sensor disposed proximate to the settop box; in that case, the signal is indicative of the on-off state of the settop box, and the state signal indicates the on-off state of the settop box. In yet another exemplary case, the signal indicative of the state of the settop box is the video signal output by the settop box. In that case, and the monitoring circuitry can monitor either the video signal and generate the state signal when the video signal is present at an input terminal of the programmable recorder or analyze the video signal and generate the state signal when a number of lines within a frame of the video signal are changing, or analyze the video signal and generate the state signal when the video signal is consistent with a television program video signal, or analyze the video signal and generate the state signal when a portion of the video signal varies from frame to frame. Alternatively, the signal indicative of the state of the settop box can be the audio signal output by the settop box, in which case, the monitoring circuitry analyses the audio signal and generates the state signal when the audio signal is present and varying in an expected manner.

According to a further aspect, the present invention provides a programmable recorder for recording video signals provided by a settop box, including a communications circuit permitting transmission of a command sequence from the programmable recorder to the settop box, monitoring circuitry which monitors a signal indicative of the operational state of the settop box and generates a state signal, logic circuitry which determines whether the settop box is operational based on the state signal and generates a determination signal, and control circuitry which effects a programmed response in response to the determination signal. According to this aspect, the monitoring circuitry monitors the signal indicative of the output of the settop box responsive to the command sequence transmitted to the settop box from the programmable recorder. When the signal indicative of the state of the settop box is the video signal output by the settop box, the monitoring circuitry can either analyze the video signal and generate the state signal when the video signal changes in response to the command sequence, or analyze the audio signal and generate the state signal when the audio signal changes in response to the command sequence.

According to a still further aspect, the present invention provides a programmable recorder for recording video signals, including circuitry for monitoring the video signal, circuitry for determining whether the video signal is recordable, and circuitry for generating a programmed response when the video signal is not recordable. In an exemplary case, the programmed response is cancellation of a scheduled recording event. In another exemplary case where the video signal is supplied by a settop box, the programmable recorder can include circuitry for effecting a communications link with a settop box provider, and the programmed response is an electronic message sent from the programmable recorder to the settop box provider indicative of an error in the settop box. In another exemplary case, the programmable recorder includes circuitry for generating an alarm, and the programmed response is an activation signal for the alarm means.

According to an additional aspect, the present invention provides a signal automatically generated by a programmable recorder indicating that a video signal received by the programmable recorder that is to be recorded during a scheduled recording event will not support the scheduled recording event.

### BRIEF DESCRIPTION OF THE DRAWINGS

These and various other features and aspects of the present invention will be readily understood with reference to the following detailed description taken in conjunction with the accompanying drawings, in which like or similar numbers are used throughout, and in which:

FIG. 1 is a high-level block diagram of a conventional personal television receiver (PTR);

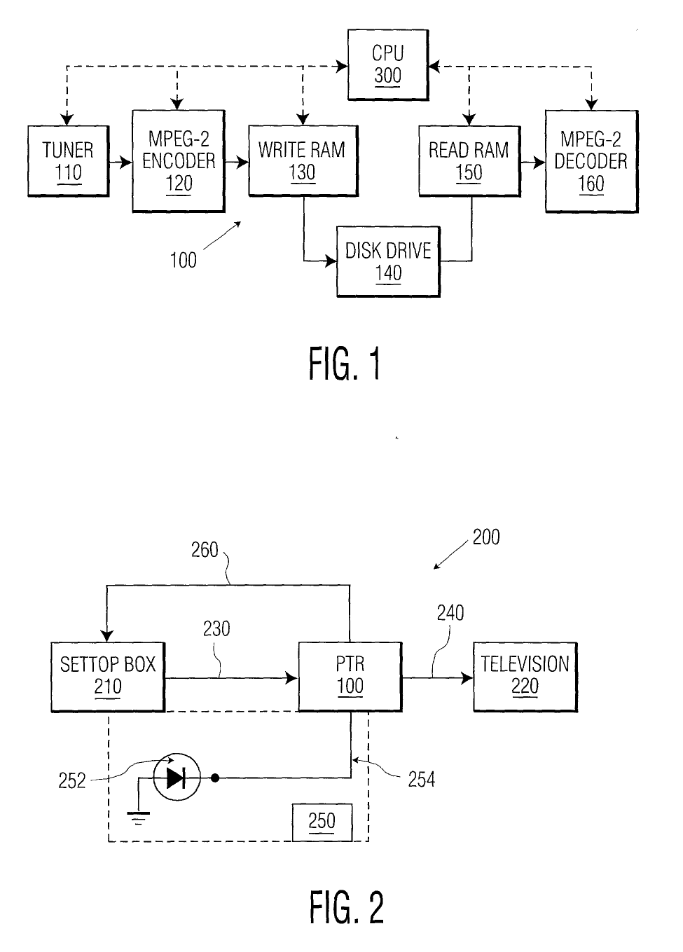

FIG. 2 is a high-level block diagram of a entertainment system including the PTR illustrated in FIG. 1;

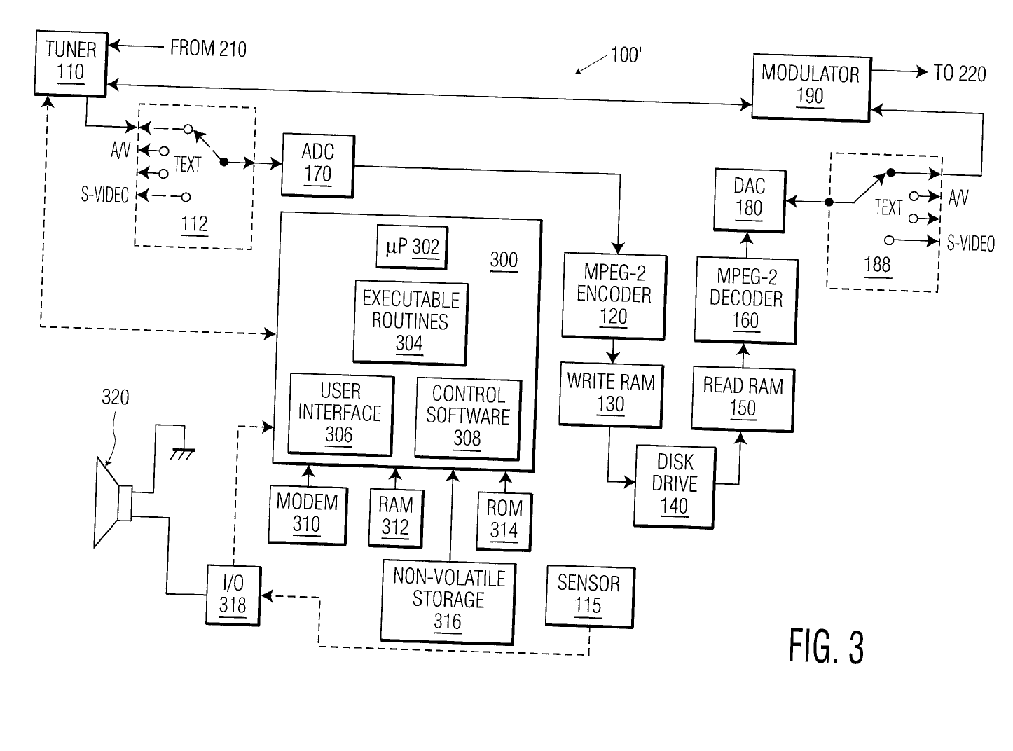

FIG. 3 is a high-level block diagram of one preferred embodiment of a PTR according to the present invention;

FIG. 4 is a high level block diagram of another preferred embodiment of a PTR according to the present invention; and

FIGS. 5A and 5B are flow charts illustrating several methods for operating the PTRs illustrated in FIGS. 3 and 4, which methods can be performed in any combination.

### DETAILED DESCRIPTION OF THE PREFERRED EMBODIMENTS

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

As mentioned above, the preferred embodiments of the present invention provide improved Personal Television Receivers (PTRs) which include components and associated logic which enable each PTR to determine whether the settop box is turned ON and/or is responding to the commands generated by the PTR before program recording is initiated. When the PTR determines that the settop box is not responding properly, the PTR according to the present invention advantageously can attempt to restore the settop box to a responsive state by generating and applying commands. Preferably, when the settop box cannot be returned to its normal operational state, the PTR suspends recording. In addition, the PTR can generate an alarm to alert the user system operator to fact that the settop box requires servicing.

Before discussing the preferred embodiments and corresponding methods according to the present invention, it should be mentioned that there are myriad ways by which the PTR can determine whether the settop box is turned ON and is responding to commands generated by the PTR. The various alternative methods can be divided into static and dynamic determination techniques, where static methods monitor the operation of the settop box directly and dynamic methods monitor the operation of the settop box in response to a sequence of commands applied by the PTR. Examples of static monitoring methods include the following:

1. The PTR can monitor the ON-OFF state of the settop box itself. This method can employ a photo detector which is placed opposite an indicator light on the settop box, or a current sensor which is inductively coupled to the settop box's line cord. Equivalent methodologies are know to one of ordinary skill in the art, and all equivalent methodologies are consider to fall within the scope of the present invention. It should be mentioned that while these methodologies can provide a positive indication that the settop box is actually turned ON, they can't, by themselves, assure that the settop box is responding to commands and/or producing the desired video output.

2. The PTR can monitor the audio and/or video output from the settop box to determine that it is present and is substantially non-blank, e.g., that the video level is changing during several selected lines. However, it will be appreciated that it is possible that the settop box is programmed to generate a video message for the user whenever, for example: it is switched to a standby state or if the cable signal is lost. For that reason, this particular method would not provide a positive indication that the settop box is responding to commands generated by the PTR.

3. The PTR can record and compare corresponding lines of several different video frames in order to assure that video information is present and is changing in a manner which is consistent with a typical TV program. It should be noted, however, that at least some of the newer PTRs and some more sophisticated settop boxes now produce moving backgrounds on their message screens which could cause this technique to give false indications that the settop box is operating normally.

Examples of dynamic monitoring methods include the following:

1. The PTR can monitor the ON-OFF state of the settop box by monitoring, for example, a pilot lamp while the PTR transmits a command sequence producing corresponding changes in the pilot lamp's output.

2. The PTR can monitor the video output from the settop box to determine that it is present and is substantially non-blank, e.g., that the video level is changing during several selected lines, and that the video level of selected lines vary as a command sequence is applied to the settop box.

3. The PTR can record and compare corresponding lines of several different video frames in order to assure that video information is present that the video frames vary as a command sequence is applied to the settop box.

4. The PTR can record one of a video or audio signal output by the settop box as a command sequence is applied to the settop box by the PTR and compare the gross signal pattern to a known standard. For example, the PTR can generate and release a MUTE command which advantageously generates a predetermined sequence of muted and normal audio signals when the settop box is responding to normal commands.

It should be noted that each of the enumerated methods has distinct advantages and disadvantages. However, many of the disadvantages can be overcome, or at least minimized, by employing a plurality of these methods in combination to thereby provide an increased level of assurance that the settop box is operating normally and responding to commands generated by the PTR.

It will be appreciated that, by using the enumerated techniques, the PTR advantageously can determine whether or not the settop box is responding. In the event that the settop box is not responding, the PTR preferably transmits one or more corrective commands. For example, in the event that the settop box appears to be in a standby or OFF state, the PTR could generate and transmit an ON command while monitoring the response of the settop box. In contrast, when the settop box appears to be in an ON state, but an applied commanded apparently has no effect on the settop box, the command advantageously could be repeated. It will be appreciated that, in the event that the command corresponding to IR signals, the strength of the signal advantageously could be increased. When a predetermined number of commands doesn't produce the desired response in the settop box, the settop box can be cycled OFF and ON in order to reboot its programming. It will be appreciated that many of the dynamic methods are also suitable for verifying the presence of a recordable signal at the input to the PTR, irrespective of the signal source available to the PTR. For example, the methods according to the present invention advantageously could be employed to determine whether a selected station is available off of an antenna; if the desired channel signal is not available, the PTR generates an alarm signal to notify the user of the problem.

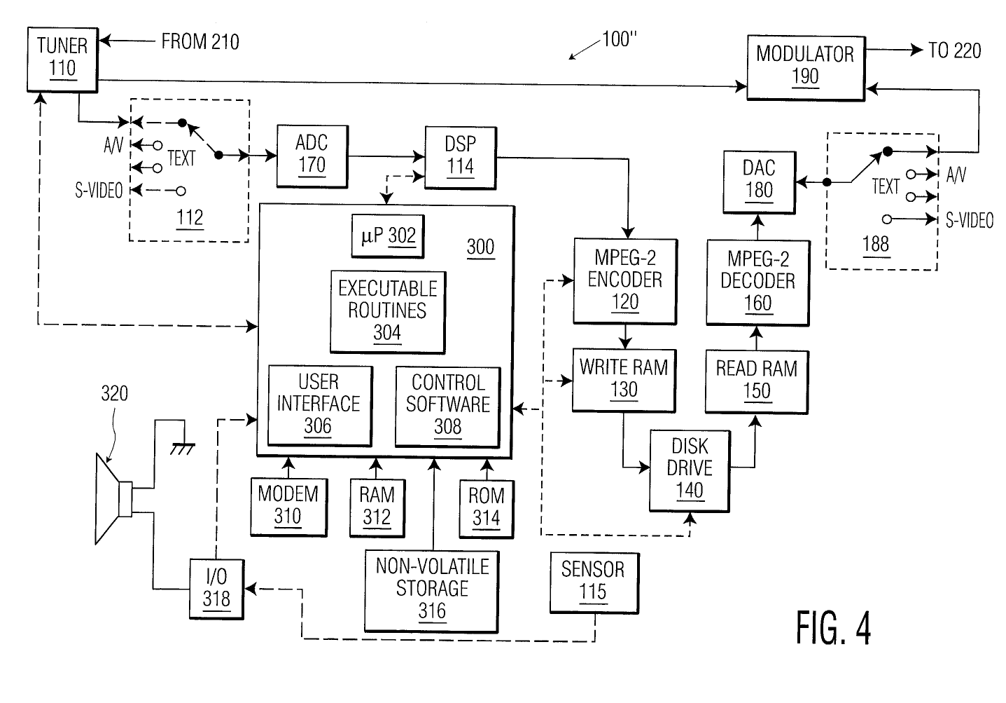

One preferred embodiment of a PTR 100′ according to the present invention, which is illustrated in FIG. 3, includes a tuner 110 connected to a modulator 190, which allows the signal applied to one input terminal of the PTR 100′ to be routed straight through to the television set 220. In will be appreciated that the input can be one of the output of settop box 210 or an antenna (not shown). The PTR 100 also includes a source selector 112, which can select between the signal generated by the tuner 110 or the A/V or S-video signals generated by the settop box 210. In any case, the output of selector 112 is provided to MPEG-2 encoder 120 via an analog-to-digital converter (ADC) 170. The MPEG-2 encoder 120, the write RAM 130, the disk drive 140, the read RAM 150 and the MPEG-2 decoder 160 are arranged in serial fashion in the exemplary embodiment illustrated in FIG. 3. The output of the MPEG-2 decoder 160 is applied to the input of digital-to-analog converter (DAC) 180, the analog output of which is routed by output selector 188 to either the modulator 190 or one of the A/V or S-video signal output ports of the PTR 110′.

The PTR 100′ illustrated in FIG. 3 advantageously includes a central processing unit (hereinafter “CPU”) 300 operatively coupled to a modem 310, a RAM 312, a non-volatile storage 316, a read-only memory (ROM) 314, and an input/output (I/O) device 318, the latter permitting the CPU 300 to receive signals generated by various sensors. It will be appreciated from the discussion above that the I/O 318 permits the CPU 300 to transmit settop box commands to the infrared (IR) transmitter 254 and to receive signals from, for example, a sensor 115 e.g., an optical sensor or a current sensor, which sensor(s) advantageously can be employed to monitor the state of the settop box 210. It will also be appreciated that the I/O 318 permits reception of control signals generated by any one of a remote control, a keyboard, a knob, a joystick, etc.

The CPU 300 illustrated in FIG. 3 advantageously can include one or more microprocessors 302, which are capable of executing stored program instructions (i.e., process steps) to control operations of the PTR 100′. These program instructions comprise parts of software modules (described below) which are stored in either an internal memory 308 of the CPU 300 or in the ROM 314, and which are executed out of the RAM 312. These software modules may be updated via the modem 310. User profile information and the like is preferably stored in the non-volatile storage 314. In this regard, the non-volatile storage 314 may comprise a-flash EPROM, NVRAM, or the like, which is capable of being reprogrammed with, e.g., a new user profile, as desired.

FIG. 3 also illustrates examples of software modules, i.e., executable routines, 304 that are executable within the CPU 300. It will be appreciated that these executable routines 304 advantageously include the enumeration methods discussed in detail above. The microprocessor 302 receivers data and control signals transmitted via I/O 318 via user interface 306 and outputs control signals via the control module 308.

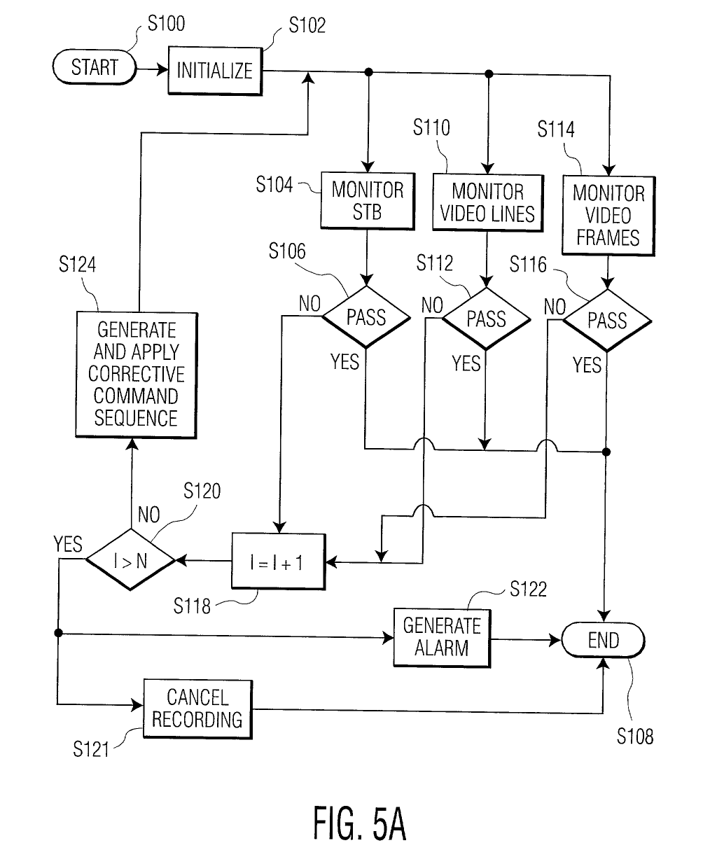

FIG. 4 illustrates another exemplary embodiment of a PTR 300″ according to the present invention, which includes all of the elements of PTR 300′ as well as a digital signal processor (DSP) 114. Additionally, the PTR 300″ includes paths permitting communication of commands and data between the DSP 114 and, in an exemplary case, the MPEG-2 encoder 120. It will be appreciated that the DSP 114 advantageously can be programmed to provide signal analyzer functions to the PTR 100″. In other words, the analyses enumerated above advantageously can be implemented via the DSP. Thus, the DSP 114, in cooperation with the CPU 300, can monitor any portion of the signal received from set 210, e.g., the audio signal, and generate a programmed response based on that respective portion of the signal. It will also be appreciated that most of the commercially available PTRs already include at least one DSP; thus, implementing the novel methods according to the present invention will have minimal impact on the price of the PTR. Moreover, given that an MPEG-2 encoder generates information indicative of interframe signal variations, the novel methods according to the present invention can be implemented using information generated by the MPEG-2 encoder 120. Furthermore, it will be appreciated that CPU 300 can compare lines or frames (or portions thereof) of the received video signal stored in either the RAM 130 or the disk drive 140 with the current video signal, e.g., the video signal output by the ADC 170.

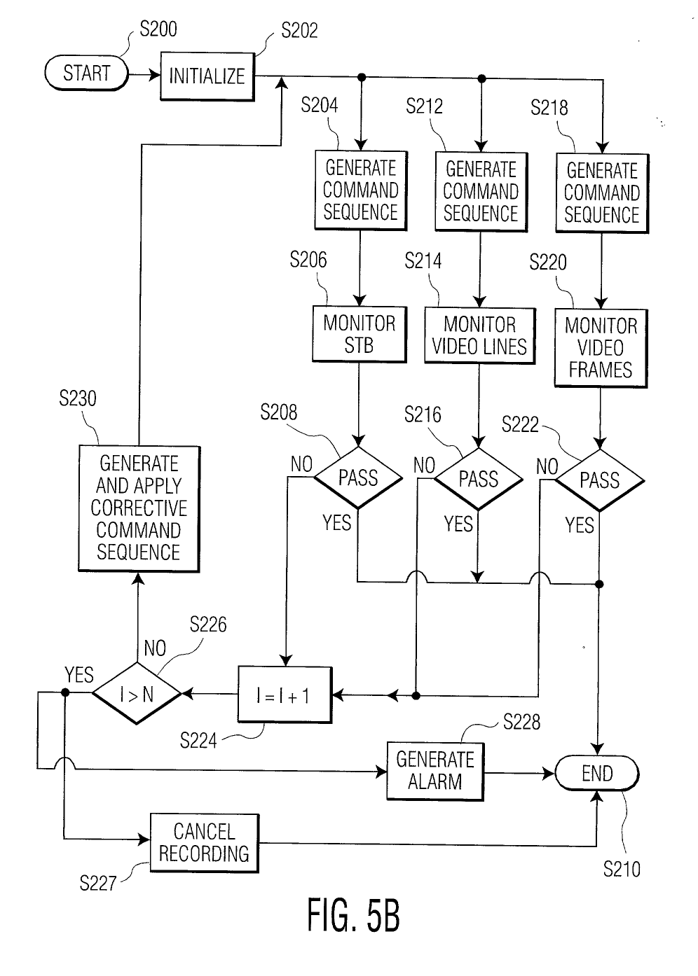

FIG. 5A is a flowchart illustrating steps for implementing the static monitoring methods according to the present invention. It will be appreciated that the flowchart illustrates the monitoring of several indicia of settop box 210 operation in parallel. It should be clearly understood that implementing the monitoring of any or all of these parameters is considered to fall within the scope of the present invention.

As illustrated in FIG. 5A, the static monitoring method according to one exemplary embodiment the present invention starts a step S100, when the PTR 100′, 100″ determines that a recording event is scheduled to occur shortly. During step S102, the PTR 100′, 100″ loads and initializes software that permits the one or more of the enumerated monitoring methods to be performed. In addition, a variable “I” is set to a predetermined value, e.g., “1”. During step S104, the operation of the settop box 210 is monitored by, for example, receiving and electrical signal indicative of operation of the settop box, e.g., a signal generated by one of a current sensor and an optical sensor, which signal(s) is(are) received via I/O 318, as discussed above. During step S106, check is performed to determine whether the settop box 210 is operating normally. When the answer is affirmative, the static monitoring method stops at step S108.

When the determination made in step S106 is negative, indicating that the settop box is not operating normally, the PTR 100, 100″ attempts corrective action, e.g., commanding the settop box ON. More specifically, during step S118, the variable I is incremented by “1” and a check is performed during step S120 to determine whether the value I is greater than a predetermined number N, i.e., the maximum number of times that the PTR 100′, 100″ will attempt to verify operation of settop box 210. If the answer at step S120 is negative, the PTR 100′, 100″ generates and applies a corrective command or command sequence to the settop box 210 during step S124. As mentioned above, this command or command sequence could be an ON command applied to the settop box, at either the original or an increased signal strength. In any event, after step S124 has been completed, the settop box is again monitored for proper operation, e.g., steps S104 ad S106 are repeated.

When the determination at step S120 is affirmative, indicating that the maximum number N-1 of attempts to confirm/restore operation of the settop box 210 have been completed, the method embodied in PTR 100′, 100″ jumps to step S121, during which the controller 300 cancels the previously scheduled recording operation and then executes step S108. Moreover, when the determination at step S120 is affirmative, the method embodied in PTR 100′, 100″ advantageously can jump to step S122, during which the PTR generates an alarm of some description to alert the user to the fact that the PTR 100′, 100″ cannot perform the desired recording operation. PTR generates an alarm of some description to alert the user to the fact that the PTR 100′, 100″ cannot perform the desired recording operation. Once the alarm is generated during step S122, the routine jumps to step S108, the routine end. It will be appreciated that the alarm signal advantageously can be an audio alarm signal, a visual alarm, signal, or a combination of the two. Moreover, since the PTR 100′, 100″ advantageously includes a modem, the alarm signal could be an e-mail message to either the user or to the settop box provider, e.g., cable system operator, who can attempt to reset the settop box in response to the PTR originated e-mail.

It will be appreciated that the method illustrated in FIG. 5A need not employ the steps S104 and S 106 but, instead can employ either steps S 110 and S 112 for monitoring multiple video lines or steps S114 and S116 for monitoring multiple lines over multiple video frames. It will also be appreciated that while steps S106, S112, and S116 are similar, each of these verification checks is illustrated separately since the criteria applied during the respective verification step is distinct with respect to the settop box parameter being monitored. It will also be appreciated that any combination of the monitoring subroutines, i.e., steps S104, S106, steps S110, 112, or steps S114, 116, advantageously can be performed by the PTR 100′, 100″; in fact, all of the subroutines discussed above can be performed, either simultaneously or in series.

FIG. 5B is a flowchart illustrating the dynamic monitoring method according to another exemplary embodiment the present invention, which starts at step S200, when the PTR 100′, 100″ determines that a recording event is scheduled to occur shortly. During step S202, the PTR 100′, 100″ loads and initializes the instructions needed to execute one or more of the enumerated dynamic monitoring methods. In addition, a variable “I” is set to a predetermined value, e.g., “1”. During step S204, a command sequence instructing the settop box 210 to perform a corresponding sequence the operations is applied to the settop box 210 and the settop box 210 is monitored during step S206 by, for example, receiving an electrical signal indicative of operation of the settop box, e.g., a signal generated by one of a current sensor and an optical sensor during the operating sequence, which signal(s) is (are) received via I/O 318, as discussed above. During step S208, a check is performed to determine whether the settop box 210 is operating normally based on the pattern of the signal generated by operation of the settop box. When the answer is affirmative, the static monitoring method stops at step S210.

When the determination made in step S208 is negative, indicating that the settop box is not operating normally, the PTR 100, 100″ attempts corrective action, e.g., commanding the settop box ON. More specifically, during step S224, the variable I is incremented by “1” and a check is performed during step S226 to determine whether the value I is greater than a predetermined number N, i.e., the maximum number of times that the PTR 100′, 100″ will attempt to verify operation of settop box 210. If the answer at step S226 is negative, the PTR 100′, 100″ generates and applies a corrective command or command sequence to the settop box 210 during step S230. As mentioned above, this command or command sequence could be an ON command applied to the settop box, at either the original or an increased signal strength. In any event, after step S230 has been completed, the settop box is again monitored for proper operation, e.g., steps S204, S206 and S208 are repeated.

When the determination at step S226 is affirmative, indicating that the maximum number N-1 of attempts to confirm/restore operation of the settop box 210 have been completed, the method embodied in PTR 100′, 100″ jumps to step S227, during which the controller 300 cancels the previously scheduled recording operation and then executes step S210. Moreover, when the determination at step S120 is affirmative, the method embodied in PTR 100′, 100″ advantageously can jump to step S228, during which the PTR generates an alarm of some description to alert the user to the fact that the PTR 100′, 100″ cannot perform the desired recording operation. Once the alarm is generated during step S228, the routine jumps to step S210, the routine end. It will be appreciated that the alarm signal advantageously can be an audio alarm signal, a visual alarm, signal, or a combination of the two. Moreover, since the PTR 100′, 100″ advantageously includes a modem, the alarm signal could be an e-mail message to either the user or to the settop box provider, e.g., cable system operator, who can attempt to reset the settop box in response to the PTR originated e-mail.

It will be appreciated that the method illustrated in FIG. 5B need not employ the steps S204, S206, and S208 but, instead, can employ either steps S212, S214, and S216 for monitoring predetermined video lines while the settop box is dynamically cycled and steps S218, S220, and S22 for monitoring predetermined sections of adjacent video frames as the settop box is dynamically cycled. It will be appreciated that while steps S208, S216, and S222 are similar, each of these verification checks is illustrated separately since the criteria applied during the respective verification step is distinct with respect to the settop box parameter being monitored. It will also be appreciated that any combination of the monitoring subroutines, i.e., steps S204, S206, and S208, steps S212, S214, and S216, or steps S218, S220 and S222, advantageously can be performed by the PTR 100′, 100″; all of the subroutines discussed above can be performed, either simultaneously or in series.

It should be mentioned that the static and dynamic monitoring methods according to the present invention are not limited to implementation in a PTR. The inventive methods advantageously can be employed in other devices downstream of the settop box, e.g., in the television with hard disk drive disclosed in U.S. Pat. No. 6,172,712.

Thus, the present invention has been described herein with reference to a particular embodiment for a particular application. Those having ordinary skill in the art and access to the present teachings will recognize additional modifications applications and embodiments within the scope thereof. It is therefore intended by the appended claims to cover any and all such applications, modifications and embodiments within the scope of the present invention.

What is claimed is:

1. A memory associated with a programmable TV recorder storing computer readable instructions for programming a processor to monitor an input port capable of receiving a video signal from a video signal source, to determine whether the video signal is recordable, and to generate an output when the processor determines that the video signal is not recordable.

2. The memory as recited in claim 1, wherein:
the video signal source comprises a settop box;
the programmable TV recorder further means which communicate with a settop box provider; and
the output comprises an electronic message sent toto the settop box provider indicating that the settop box is not operational.

3. The memory as recited in claim 1, wherein:
the video source comprises an antenna; and
the output comprises an alarm signal indicating that the programmable TV recorder is not receiving the video signal at the input port.

4. The memory as recited in claim 1, wherein the output is a signal which cancels a scheduled recording event.

5. A memory associated with a programmable TV recorder storing computer readable instructions for programming a processor to monitor a video signal from a video signal source for changes, to determine, based on said changes, whether the video signal is recordable and to generate an output signal when the processor determines that the video signal is not recordable.

6. The memory as recited in claim 5, wherein:
the processor is programmed to determine that the video signal is recordable when the video signal analyzed by the processor is changing.

7. The memory as recited in claim 5, wherein:
the processor is programmed to determine that the video signal is recordable when a portion of the video signal in a video frame monitored by the processor changes with respect to the corresponding portion of the signal in another frame.

8. The memory as recited in claim 5, wherein:
the processor is programmed to send at least one command signal to the video source and to determine that the video signal is recordable when the video signal monitored by the processor varies dynamically in response to the command signal.

9. The memory as recited in claim 5, wherein processor is programmed to determine that the video signal is recordable when the video signal received by the programmable TV recorder changes in a manner which is consistent with expected changes in a television program signal.

10. The memory as recited in claim 5, wherein processor is programmed to determine that the video signal is recordable when the video signal received by the programmable TV recorder changes in a manner which is consistent with expected frame to frame changes in a television program video signal.

11. The memory as recited in claim 5, wherein:
the processor monitors an audio signal associated with the video signal; and
the processor is programmed to determine that the video signal is recordable when the audio signal analyzed by the programmable recorder is not noise.

12. A programmable recorder for recording video signals provided by a settop box, comprising:
monitoring circuitry, which monitors a signal indicative of the operational state of the settop box and generates a state signal;
means which determine whether the settop box is operational based on the state signal and generates a determination signal; and
control circuitry, which effects a programmed response in response to the determination signal.

13. The programmable recorder as recited in claim 12, wherein the programmed response comprises cancellation of a schedule recording event.

14. The programmable recorder as recited in claim 12, wherein:
the programmable recorder further comprises:
a communications circuit permitting communication between the programmable recorder and a settop box control facility; and
the programmed response comprises transmitting an electronic message to settop box control facility indicating that the settop box is not operational.

15. The programmable recorder as recited in claim 12, wherein:
the programmable recorder further comprises a sensor disposed proximate to the settop box;
the signal is indicative of the on-off state of the settop box; and
the state signal indicates the on-off state of the settop box.

16. The programmable recorder as recited in claim 12, wherein:
the signal indicative of the state of the settop box comprises the video signal output by the settop box; and
the monitoring circuitry monitors the video signal and generates the state signal when the video signal is present at an input terminal of the programmable recorder.

17. The programmable recorder as recited in claim 12, wherein:
the signal indicative of the state of the settop box comprises the video signal output by the settop box; and
the monitoring circuitry analyses the video signal and generates the state signal when at least a portion of the video signal is changing.

18. The programmable recorder as recited in claim 12, wherein:
the signal indicative of the state of the settop box comprises the video signal output by the settop box; and
the monitoring circuitry analyses the video signal and generates the state signal when the video signal is consistent with a television program signal.

19. The programmable recorder as recited in claim 12, wherein:
the signal indicative of the state of the settop box comprises the video signal output by the settop box; and
the monitoring circuitry analyses the video signal and generates the state signal when a selected portion of the video signal varies from frame to frame.

20. The programmable recorder as recited in claim 12, wherein:
the signal indicative of the state of the settop box comprises the video signal output by the settop box; and
the monitoring circuitry analyses the video signal and generates the state signal when a selected portion of the video signal is changes from frame to frame and the video signal is consistent with a television program signal.

21. The programmable recorder as recited in claim 12, wherein:
the signal indicative of the state of the settop box comprises the audio signal output by the settop box; and
the monitoring circuitry analyses the audio signal and generates the state signal when the audio signal is present and varying in an expected manner.

22. A programmable recorder for recording audio/video program signals provided by a settop box, comprising:
a communications circuit permitting transmission of a command sequence from the programmable recorder to the settop box;
monitoring circuitry that monitors a signal indicative of the operational state of the settop box and generates a state signal;
means which determine whether the settop box is operational based on the state signal and generates a determination signal; and
control circuitry that effects a programmed response in response to the determination signal,
wherein:
the means monitors the signal indicative of the output of the settop box responsive to the command sequence transmitted to the settop box from the programmable recorder.

23. The programmable recorder as recited in claim 22, wherein:
the signal indicative of the state of the settop box comprises a program signal output by the settop box; and
the monitoring circuitry analyses the video signal and generates the state signal when the program signal changes in response to the command sequence.

24. A programmable recorder for recording video signals, comprising:
means for monitoring the video signal;
means for determining whether the video signal is recordable; and
means for generating a programmed response when the video signal is not recordable.

25. The programmable recorder as recited in claim 24, wherein:
the programmed response comprises cancellation of a scheduled recording event.

26. The programmable recorder as recited in claim 24, wherein:
the video signal is supplied by a settop box;
the programmable recorder further comprises:
means for effecting a communications link with a settop box provider; and
the programmed response is an electronic message sent from the programmable recorder to the settop box provider indicative of an error in the settop box.

27. A signal automatically generated by a programmable recorder indicating that a video signal received by the programmable recorder that is to be recorded during a scheduled recording event will not support the scheduled recording event.
